(19) United States
(12) Patent Application Publication
(10) Pub. No.: US 2012/0024484 A1
(43) Pub. Date: Feb. 2, 2012

(54) Door machine mechanism of fireproof door

(76) Inventor: Chung-Hsien Hsieh, Taipei Hsien (TW)

(21) Appl. No.: 12/805,350

(22) Filed: Jul. 27, 2010

(51) Int. Cl. E06B 9/88

(52) U.S. Cl. 160/291

(57) ABSTRACT

A door machine mechanism of the fireproof door comprises a force exerted end which is activated to roll a rotary axle and a loading end for receiving the weight of the door curtain. The rotary axle comprises an internal axle and two external axles. The force exerted end and the loading end are applied on the internal axle and the external axle respectively. The internal axle and the external axle are normally coupled via a clutch mechanism. A torsion spring brake mechanism is used to normally brake the rotary axle against the load of the loading end by changing the inner diameter of the torsion spring, or when the torsion spring brake mechanism is subjected to an external force from the force exerted end, the rotary axle is released. As such, the clutch mechanism is controlled to interrupt the coupling of the internal axle and the external axle in the event of the fire alarm such that the door curtain falls and shuts the fireproof door.

### BACKGROUND OF THE INVENTION

1. Field of the Invention

This invention relates to a door machine mechanism, more particularly to a door machine mechanism for a fireproof door.

2. Brief Description of Prior Art Generally, the door machine used in a fireproof door is classified into two types depending on its operational mode: one is a failsafe mode and the other is a non-failsafe mode. In the case of the failsafe mode, a brake is immediately released by a brake device so as to shut the fireproof door in the absence of electrical power regardless of the reason of power failure. If fire breaks out in the presence of electrical power, the power is cut off by, for example, smoke detectors, temperature sensors or other fire detecting devices, or is cut off mechanically by a fusible link device which is molten at a high temperature in the fire in such a manner that the brake is released, and the door curtain shuts the fireproof door by its own weight. In this mode, the flame or escape of dense smoke can be blocked instantly when the fire occurs, if the cause of power failure is a fire indeed. Therefore, the main feature of the failsafe mode is more active for fire prevention. However, if the cause of the power failure is not a fire, a manually operating means has to be used for driving the door machine to open the door so as to maintain regular access for personnel.

On the other hand, in non-failsafe mode, the brake device is still maintained in a brake-actuated state without closing the fireproof door immediately in the absence of electrical power, regardless of the reason of power failure. Only if the occurrence of a fire is definitely confirmed by, for example, smoke detectors, temperature sensors or other fire detecting devices, a current transiently supplied from a reserved power source such as a capacitor, a battery or the like is supplied to the brake device for releasing the brake for a short period of time, or a fusible link is molten at a high temperature for mechanically actuating the brake device so as to release the brake, in such a manner that the door curtain falls down and shuts the fireproof door by its own weight. In this mode, the main advantage is that no inconvenience is encountered for personnel regular access is the main advantage, if the fire is not the cause of power failure. However, if the power failure is caused by a fire, and if the fire point is remote from the fire detecting devices or the fusible link, it is impossible to close the fireproof door immediately. Therefore, this mode has less safety for fire prevention.

Some documents associated with a failsafe mode door machine of a fireproof door have been proposed, such as U.S. Pat. Nos. 5,673,514 and 5,893,234 in which two electromagnets are used to maintain the brake-actuating state in the presence of electrical power, or to release the brake immediately so as to close the fireproof door in a power failure condition. The structure thereof is very complicated and has a large volume. On the other hand, a lot of documents concerning non-failsafe mode door machine of fireproof door such as U.S. Pat. Nos. 5,203,392 and 5,386,891 are disclosed, in which manual operation has to be conducted by switching operation mode, or a chain disk is rotated by pulling an endless chain and meanwhile the brake is released so as to rotate the rotary axle. Thus, there is still room for further improvements on the implementation and the structure of a door machine mechanism.

### SUMMARY OF THE INVENTION

The main object of the present invention is to provide a novel door machine mechanism of a fireproof door capable of obviating the disadvantages such as complexity in structure, large volume and inconvenience in operation present in prior art.

In order to achieve the aforementioned and the other objects, the door machine mechanism of the fireproof door according to the present invention comprises: a force exerted end, which is activated to drive a rotary axle; and a loading end for supporting the weight of the door curtain, the rotary axle comprising an internal axle and an external axle. The force exerted end and the loading end are applied on the internal axle and the external axle respectively, and the internal axle and the external axle are normally coupled by a clutch mechanism. A torsion spring brake mechanism is used to normally brake or release the rotary axle by reducing or enlarging the inner diameter of the torsion spring. When an external force is exerted on force exerted end in a manner that the torsion spring is de-twisted or its inner diameter is enlarged, the rotary axle is released and rotated. In the case that no external force is exerted thereto, the loading from the weight of the door curtain is normally transferred to the torsion spring so that the torsion spring is twisted or its inner diameter is reduced, whereby braking the rotary axle. In this way, the clutch mechanism is controlled to interrupt the coupling of the internal axle and the external axle such that the door curtain falls and shuts the fireproof door in the event of a fire alarm. Thus, flame or smoke can be blocked immediately.

According to the present invention, each end of the torsion spring is provided with a protrusion loop having a twisting side and a de-twisting side. The external force exerted from the force exerted end is applied on the de-twisting side so that the torsion spring is de-twisted or its inner diameter is enlarged and the rotary axle is released and rotated by the external force. Alternatively, the loading on the loading end from the weight of the door curtain is applied on the twisting side so that the torsion spring is twisted or its inner diameter is reduced to brake the rotation of the rotary axle caused by the weight of the door curtain. With aid of the torsion spring brake mechanism, not only the external force is allowed to roll up or down the door curtain, but also the rotation of the rotary axle caused by the weight of the door curtain is braked.

According to the present invention, the rotary axle of the door machine mechanism is simplified and compacted in structure by arranging the internal axle in the external axle.

According to the present invention, the door machine mechanism of the fireproof door can be adapted to a failsafe door machine by introducing an electromagnetic clutch or into a non-failsafe door machine by introducing a mechanical clutch. Most of the components used in both cases are the same. Not only lower manufacturing cost, fewer components and simplicity in production can be achieved, but also smaller inventory and simplicity in assembly can be realized.

According to the present invention, the door machine mechanism of the fireproof door further has a circuit by which the electromagnetic clutch can be excited in the presence of a normal power supply. The circuit may further includes a delay circuit formed by a plurality of capacitors, which are charged in the presence of the normal power supply. In the event of a power interruption caused by a fire, the electromagnetic clutch can be excited for a short time excitation so as to delay shutting of the fireproof door for the personnel evacuation.

### DETAILED DESCRIPTION OF PREFERRED EMBODIMENTS

The technical contents of the present invention will become more apparent from the detailed description of the preferred embodiments in conjunction with the accompanying drawings. It is noted that the preferred embodiments which are purely illustrative do not intend to restrict the implementation range of the present invention.

Firstly referring to FIGS. 1 to 1f, an embodiment of a failsafe type door machine mechanism of a fireproof door of the present invention is described. The door machine mechanism 1 of the present invention is used to release a rotary axle of a door curtain so as to close the fireproof door in the event of power failure. The door curtain is composed of a plurality of slats. The door machine mechanism 1 essentially comprises a housing 10 defining an accommodation space. A central axle 12 is rotatably arranged in the housing 10. A torsion spring brake mechanism 20 is arranged to encircle around the circumference at the left end of the central axle 12 for braking or releasing the central axis 12 by twisting or de-twisting one or more torsion springs 201 of the torsion spring brake mechanism 20. The details of the torsion spring brake mechanism 20 will be described later. A drive mechanism 30 is disposed on the central axle 12 in such a manner that the torsion springs 201 is de-twisted to the effect that the inner diameter thereof is enlarged when an external forced is exerted on the drive mechanism 3 whereby releasing and rotating the central axle 12. A first external axle 14 is loosely fitted on the central axle 12. A clutch mechanism 50 is disposed on the central axle 12 at the right end of the first external axle 14 for connecting and disconnecting the central axle 12 and the first external axle 14 in a control manner. A second external axle 16 adjacent to the left end of the first external axle 14 is loosely fitted on the central axle 12 and firmly provided with an output pulley 161 which is coupled with a reel of the door curtain (not shown). A reduction mechanism 40 including gear groups 401, 401′ is interposed between the first external axle 14 and the second external axle 16 and capable of converting a high rotation speed at the first external axle 14 into a lower rotation speed at the second external axle 16. When no external force is exerted on the drive mechanism 30, the loading from the weight of the door curtain is normally transmitted to the torsion spring 201 through the output pulley 161, the second external axle 16, the reduction mechanism 40, the first external axle 14, the clutch mechanism 50 and the central axle 12 so that the torsion springs 201 are twisted to the effect that the inner diameter thereof is reduced, whereby braking and holding the central axle 12. In the event of the fire alarm and power failure, the clutch disconnects the first external axle 14 from the central axle 12 such that the door curtain falls down by its own weight and shuts the fireproof door.

According to the present invention, a centrifugal brake mechanism 60, which is well known, is arranged to encircle the outer circumference of the first external axle 14 for limiting the rotation speed of the first external axle 14 by a friction on the brake drum caused by a centrifugal force. The centrifugal force is generated when the first external axle 14 rotates. The housing 10 is partitioned into a plurality of spaces by a plurality of partitioning plates 101, 101. The brake drum 601 is fixed on one of the partitioning plates 101. One end of the first external axle 14 is rotatably and is centrally aligned with the brake drum 601, while the other end is provided with a driven disc 141.

The clutch mechanism 50 is located on the opposite side of the driven disc 141 which comprises an electromagnet 501 fixed on the other one of the partitioning plates 101′ of the housing 10. A drive member 503 has an end face adjacent to the electromagnet 501 and is fixed on the central axle 12. A follower 505 which is provided with a brake shoe 533 and interposed between the drive member 503 and the driven disc 141 is biased by an elastic plate 507 and is coupled with the driven disc 141. When the electromagnet 501 is not excited, the follower 505 is biased toward the driven disc 141, as shown in FIG. 1a. At the same time, the coupling of the central axle 12 and the first external axle 14 is disconnected. On the other hand, when the electromagnet 501 is excited, the follower 505 is attacked toward the drive member 503 by the electromagnet 501 against the elastic plate 507, as shown in FIG. 1b. In the same time, the central axle 12 and the first external axle 14 are coupled. Moreover, a circuit is provided to excite the electromagnet 501 in the presence of the normal power supply, so that the central axle 12 and the first external axle 14 are normally coupled.

Furthermore, the housing 10 is provided with a second housing 10′ for supporting one end of the second external axle 16, and the torsion spring brake mechanism 20 is received in the second housing 10′. The torsion spring brake mechanism 20 is provided with a hub 18 which rotatably supports one end of the central axle 12. One end of the hub 18 is fixed on the second housing 10′. As shown in FIGS. 1e and 1f, the torsion spring brake mechanism 20 has one or more torsion springs 201. Two ends of each torsion spring 201 are free ends. Each torsion spring 201 constricts the circumference of the other end of the hub 18. Each free end of each torsion spring 201 is formed with a protrusion loop 201a. An inner ring portion 203 and an outer ring portion 205 are concentric and rotatable with respect to each other. The inner ring portion 203 is fitted and fixed on the central axle 12. A pair of blocking plates 2031 are erected on one top face of the inner ring portion 203 in the longitudinal direction and arranged opposite to each other in the radial direction. A pair of push-plates 2051 are erected on one top face of the outer ring portion 205 at the same side with the blocking plates 2031 and arranged opposite to each other in the radial direction in such a matter that the blocking plates 2031 and the push-plates 2051 are disposed alternately around the torsion springs 201. The blocking plates 2031 and the push-plates 2051 are concentric and arranged at the same radius. The protrusion loop 201a is received in a gap between one blocking plate 2031 and one push-plate 2051 which are adjacent to each other. Each protrusion loop 201a has a twisting side a and a de-twisting side b. The “twisting side” refers to as the side on which a forcer is exerted, causing the torsion to be twisted. The “de-twisting side” refers to as the side on which a force is exerted, causing the torsion to be de-twisted. The blocking plates 2031 are respectively arranged between two twisting sides a and would be blocked by the twisting sides a. Rotation of the outer ring portion 205 causes the push-plates 2051 to be abutted on the de-twisting sides b and hence causes the torsion springs 201 to be de-twisted as shown in FIG. 1c so that the rotation of the outer ring portion 205 is kept going. In addition, the drive mechanism 30 includes a chain wheel 301 and a chain wound on the outer circumference of the chain wheel 301. The chain wheel 301 is fixed on the outer ring portion 205.

The central axle 12 can be indirectly rotated by pulling the chain.

Referring to FIGS. 1 and 4, the coil R1 of the electromagnet 501 of the clutch mechanism 50 is excited in the presence of the normal power supply such that the central axle 12 and the first external axle 14 are coupled with each other normally. At this moment, if the chain is pulled, then the push-plates 2051 are rotated and abutted on the de-twisting sides b of the protrusion loops 201a of the torsion springs 201 so that the torsion springs 201 are subject to a de-twisting torque and hence de-twisted. The inner diameter of the torsion springs 201 is enlarged and the hub 18 is released from the torsion springs 201. Then, the torsion springs 201 are rotated along the circumference of the hub 18, so the blocking plates 2031 on the other side of the protrusion loops 201a are also rotated together. The drive force applied on the central axle 12 is transferred through the first external axle 14 and the second external axle 16 to the reel of the door curtain so as to roll up or down the door curtain. On the other hand, if the drive mechanism 30 is not operated, the loading of the weight of the door curtain on the output pulley 161 is transferred to the central axle 12 through the first external axle 14 and the second external axle 16. In such a case, the blocking plates 2031 of the inner outer portion 203 are abutted on the twisting sides a of the protrusion loops 201a of the torsion springs 201 so that a twisting torque is applied to the torsion springs 201 and the torsion springs 201 are further twisted. As the torsion springs 201 are further twisted, the torsion springs 201 constrict on the hub 18 more firmly and hence become unmovable and unrotatable about the hub 18. As a result, the blocking plates 2031 are blocked by the unmovable and unrotatable torsion springs 201, and hence the central axle 12 is braked and held.

In the event of power failure, the clutch mechanism 50 immediately interrupts the coupling of the central axle 12 and the first external axle 14 such that the door curtain falls down by its own weight. Even when fire breaks out in the presence of the power supply, the power supply can be interrupted by conventional fire detecting devices, for example, smoke detectors, temperature sensors or other fire detecting devices. Furthermore, a delay circuit C1 formed by a plurality of capacitors may be included in the circuit. The capacitors which are charged in the presence of the power supply supply a current to the coil R1 of the electromagnet 501 for a short time in the event of the power failure the electromagnet 501 is excited transiently, for example for about 10 seconds, so as to delay the shutting of the fireproof door for immediate personnel evacuation.

Furthermore, FIGS. 2 to 2c illustrate an embodiment of a non-failsafe door machine mechanism of a fireproof door of the present invention. This embodiment different from the preceding one in that a mechanical type of clutch mechanism 50′ is included to couple the central axle 12 and the first external axle 14 or disconnect them from each other. According to this invention, the other end of the central axle 12 is rotatably support on the other partitioning plate 101′ at the outer side of the partitioning plate 101′. The clutch mechanism 50′ has a bushing 52 disposed on the right side of the driven disc 141. The bushing 52 is arranged in such a manner that the bushing 52 can slide axially therein and rotate together with the central axle 12, but cannot rotate with respect to the central axle 12. A circumferential sliding groove 521 is formed along the outer circumference of the bushing 52. A disk spring 54 is interposed between the bushing 52 and the partitioning plate 101′. One end of the bushing 52 is biased by the disk spring 54 such that the other end thereof is normally abutted against the driven disk 141. A first teeth portion 141a is formed on the end face of the driven disk 141 which is to be engaged with a second teeth portion 523 formed on the end face of the other end of the bushing 52, as shown in FIGS. 2 and 2a.

According to the present invention, a rocking lever 56 is provided. The middle portion of the rock lever 56 is pivoted on the housing 10. The inner end of the rocking lever 56 is provided with a protruding pin 561 extending into the sliding groove 521. The outside end of the rocking lever 56 extends outside of the housing 10. A guide member 57 is fixed on the housing 10 corresponding to the outer end of the rocking lever 56. A slider 58 inserted in the guide member 57 is slidably guided in the guide member 57. The slider 58 is biased by an elastic element 59 and connected with a conventional fire detecting device 70. The slider 58 is arranged in place so that the outer end of the rocking lever 56 can be operated by one end of the slider 58. The slider 58 is held by the fire detecting device 70 so that the slider 58 is not abutted to the rocking lever 504. The fire detecting device 70 may be a smoke detector, temperature sensor or other fire detecting device, preferably a fusible link which is molten and broken at a temperature exceeding its melting point so that the slider 58 is released and hits the outer end of the rocking lever 56 and swings the inner end of the rocking lever 56. Due to the projecting pin 561 extending into the sliding groove 521, the bushing 52 is axially moved by the projecting pin 561 against so as to resist the disk spring 54 such that the bushing 52 is separated from the driven disc 141. As a result, the coupling of the central axle 12 and the first external axle 14 is disconnected.

According to the present invention, the door machine mechanism can be modified into a failsafe door machine or a non-failsafe door machine easily. The most of components for the door machine mechanism can be applied to either the failsafe one or the non-failsafe one. Therefore, not only low manufacturing cost, fewer components and simplicity in production can be achieved, but also smaller inventory and easy replacement can be realized.

While the preferred embodiments have been described as above, it is noted that the preferred embodiments are not intended to restrict the scope of implementation of the present invention. Modifications and variations can be made without departing from the spirit and scope of the claims of the present invention

### BRIEF DESCRIPTION OF ACCOMPANYING DRAWINGS

FIG. 1 is a sectional view showing the door machine mechanism of a failsafe type fireproof door according to the present invention.

FIG. 1a is a partially enlarged view of the encircled portion in FIG. 1 in which the clutch mechanism is shown to be in a separated state.

FIG. 1b is a partially enlarged view of the encircled portion in FIG. 1 in which the clutch mechanism is shown to be in an engaged state.

FIG. 1c is a sectional schematic view taken along the line 1c-1c of FIG. 1.

FIG. 1d is a perspective sectional view showing the door machine mechanism of FIG. 1.

FIG. 1e is an exploded perspective view showing the torsion spring brake mechanism of the present invention.

FIG. 1f is an exploded perspective enlarged view in another direction showing the torsion spring brake mechanism in FIG. 1e of the present invention.

FIG. 1g is a schematic view showing a circuit used in the door machine mechanism of a failsafe type fireproof door according to the present invention.

FIG. 2 is a sectional view showing an embodiment of a non-failsafe type door machine mechanism of fireproof door of the present invention.

FIG. 2a is a schematic sectional view taken along the line 2a-2a in FIG. 2.

FIG. 2b is a dynamic schematic view of the clutch mechanism in FIG. 2 in which the clutch mechanism is shown to be in separated state.

FIG. 2c is a sectional perspective view showing the door machine mechanism in FIG. 2.

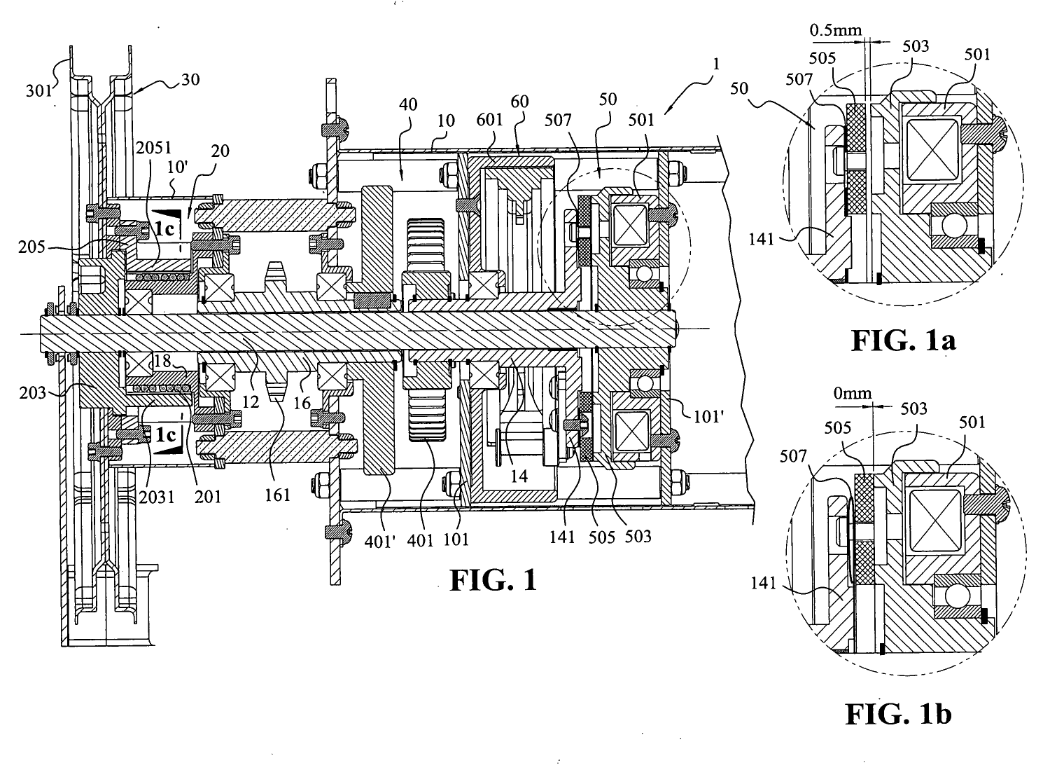

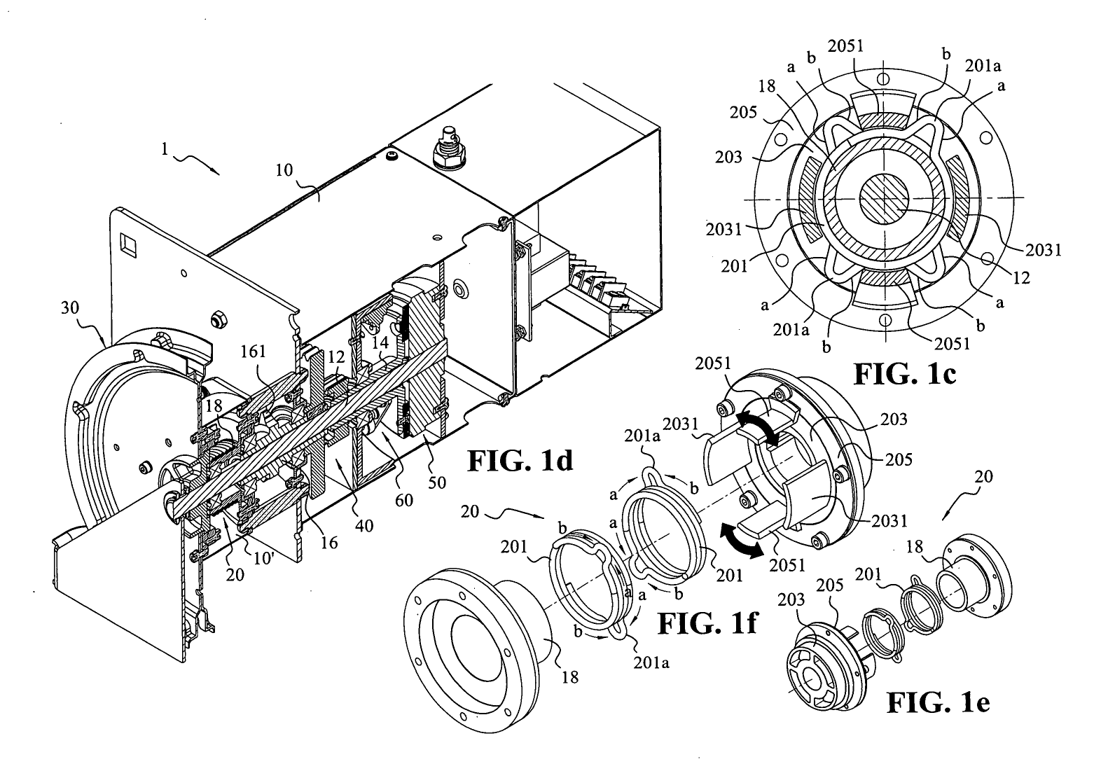

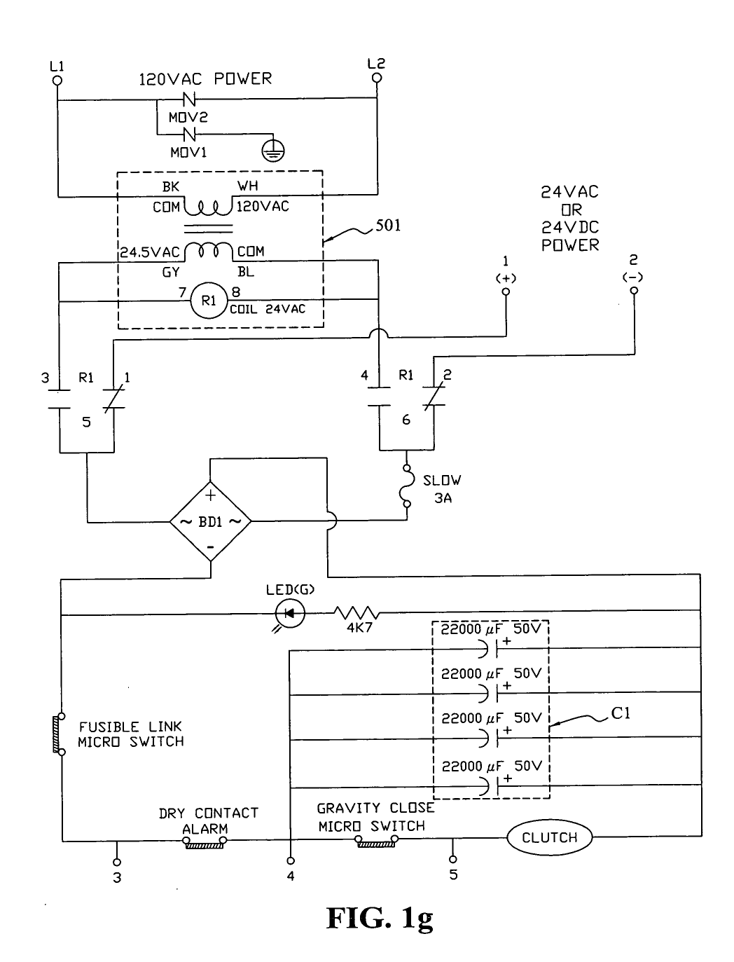

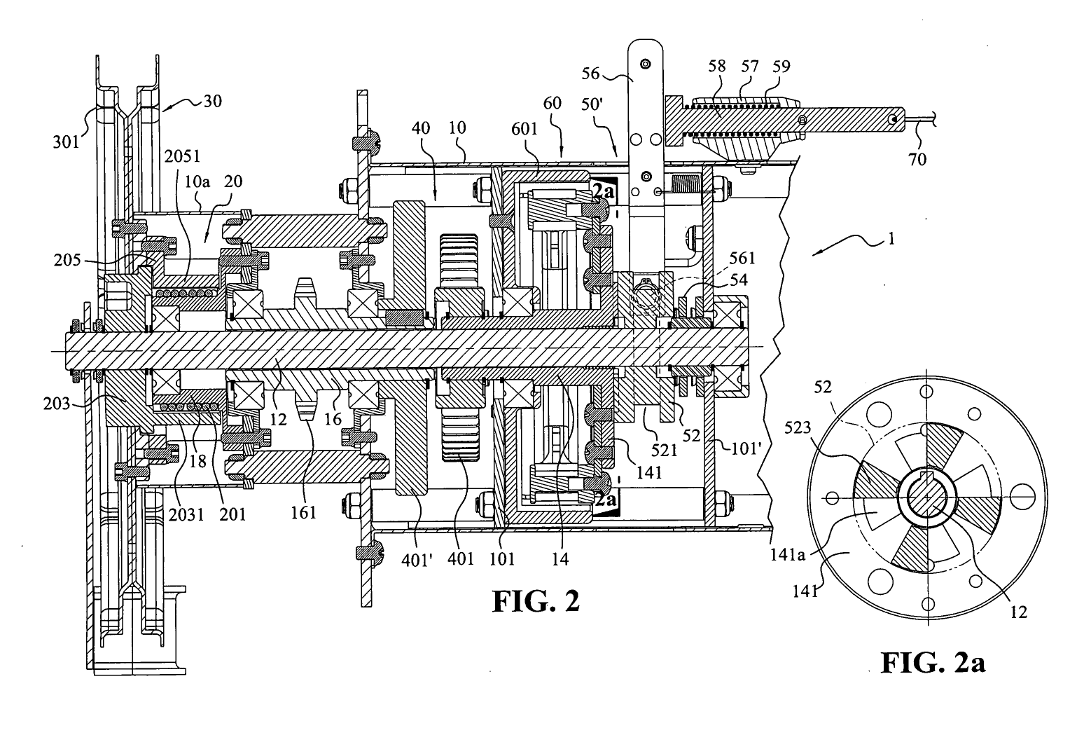

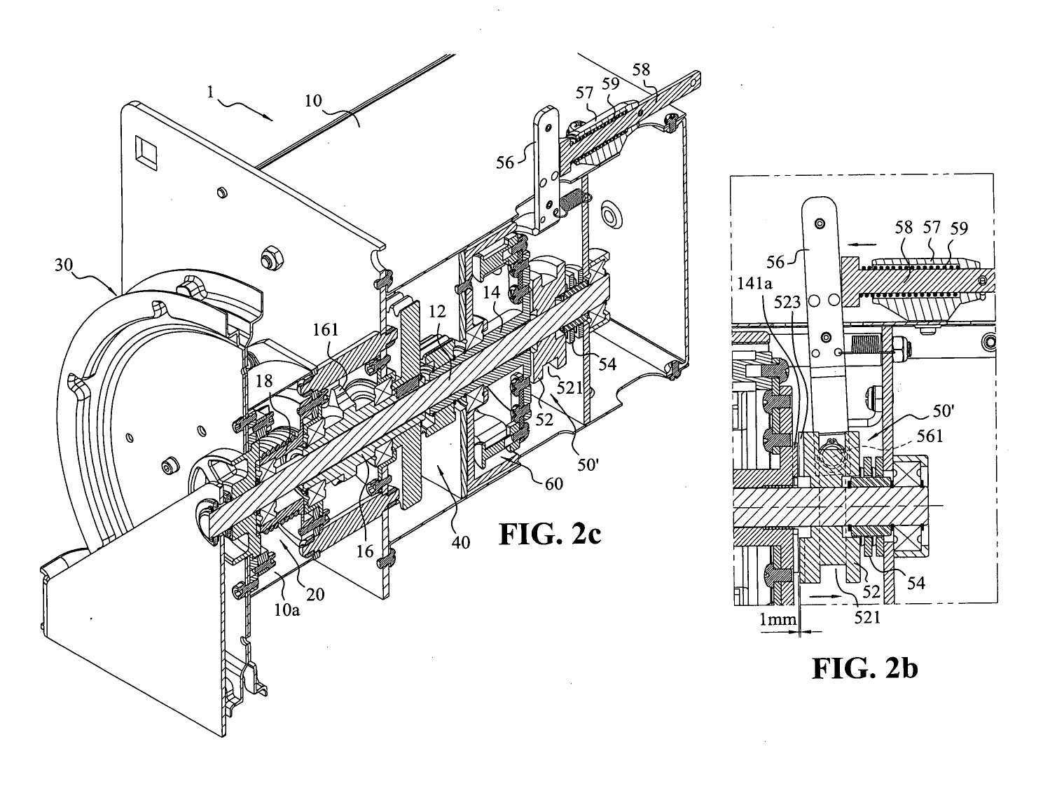

What is claimed is:

1. A door machine mechanism (1) of a fireproof door, which is used to release a reel of a door curtain in an event of a fire accidence, said door machine mechanism (1) comprising:
a housing (10) defining an interior space;
a central axle (12) pivoted in said housing (10);
a torsion spring brake mechanism (20) arranged around a circumference of a left end on said central axle (12), said torsion spring brake mechanism (20) including at least one torsion spring (201) for controlling said central axle (12) to be either in brake-actuated state or in brake-release state;
a drive mechanism (30) disposed at a first set position of said central axle (12), for actuating said torsion spring brake mechanism (20) to expand an inner diameter of said torsion spring (201) and rotate the central axle (12) when an external force is exerted thereon;
a first external axle (14) loosely fitted on a second set position between two ends of said central axle (12);
a clutch mechanism (50, 50′) disposed on a right end of the first external axle (14) and fixed on said central axle (12) for connecting or disconnecting said central axle (12) and said first external axle (14) in control manner;
a second external axle (16) adjacent to a left end of said first external axle (14) and fitted on said central axle (12) in loose fit and an output pulley (161) being fixed thereon to be linked with the reel of the door curtain;
a reduction mechanism (40) connecting said first external axle (14) and said second external axle (16), a rotation speed at said first external axle (14) being reduced to said second external axle (16);
wherein a weight of the door curtain constantly acts on the output pulley (161) of said second external axle (16) to induce said torsion spring brake mechanism (20) to shrink the inner diameter of said torsion spring (201) and brake said central axle (12); and in the event of the fire alarm, said clutch mechanism (50) disconnects said central axle (12) from said first external axle (14) so that the door curtain falls down by its own weight thereof and shuts the fireproof door.

2. The door machine mechanism (1) of the fireproof door as claimed in claim 1, further comprising a centrifugal brake mechanism (60) arranged around an outer circumference of said first external axle (14) for limiting the rotation speed of said first external axle (14) by friction on a brake drum (601) caused by a centrifugal force, the centrifugal force being generated with the rotation of said first external axle (14).

3. The door machine mechanism (1) of the fireproof door as claimed in claim 2, wherein the interior space of said housing (10) is partitioned by a plurality of partitioning plates (101, 101′); said brake drum (601) of said centrifugal brake mechanism (60) is fixed on one of the partitioning plates (101); a left end of said first external axle (14) is rotatably positioned at a center of said brake drum (601), and a right end of said first external axle (14) is provided with a driven disc (141) on the right end thereof.

4. The door machine mechanism (1) of the fireproof door as claimed in claim 3, wherein said torsion spring brake mechanism (20) includes a hub (18) for supporting said central axle (12), one end of said hub (18) being fixed on said housing (10); said torsion spring brake mechanism (20) has one or more torsion springs (201), two ends of each torsion spring (201) being free ends and each torsion spring (201) constricting an outer circumference of the other end of the hub (18) with its inner diameter, a protrusion loop (201a) being formed on each free end of each torsion spring (201); an inner ring portion (203) and an outer ring portion (205) are concentric and rotatable with respect to each other, said inner ring portion (203) being fitted and fixed on said central axle (12); a pair of blocking plates (2031) are erected on one top face of said inner ring portion (203) in a longitudinal direction and arranged opposite to each other in a radial direction, and a pair of push-plates (2051) are erected on one top face of said outer ring portion (205) at the same side with the blocking plates (2031) and arranged opposite to each other in the radial direction in such a manner that the blocking plates (2031) and the push-plates (2051) are disposed alternately around said torsion springs (201); both said blocking plates (2031) and said push-plates (2051) are concentric and arranged at the same radius and said protrusion loop (201a) is received in a gap between one blocking plate (2031) and one push-plate (2051) which are adjacent to each other.

5. The door machine mechanism (1) of the fireproof door as claimed in claim 4, wherein said clutch mechanism (50) comprises an electromagnet (501) fixed on the other one of the partitioning plates (101′) of said housing (10); a drive member (503) having an end face adjacent to said electromagnet (501) and fixed on said central axle (12); a follower (505) with one end face having a brake shoe between said drive member (503) and said driven disc (141), said follower (505) being biased by an elastic plate (507) and coupled with the driven disc (141).

6. The door machine mechanism (1) of the fireproof door as claimed in claim 5, wherein the electromagnet (501) is excited under a normal power supply condition.

7. The door machine mechanism (1) of the fireproof door as claimed in claim 1, wherein said drive mechanism (30) includes a chain wheel (301) and a chain wound around said chain wheel (301), said chain wheel (301) being fixed on said outer ring portion (205), whereby the torsion spring brake mechanism (20) is actuated to rotate said central axle (12) by pulling said chain.

8. The door machine mechanism (1) of the fireproof door as claimed in claim 7, wherein said clutch mechanism (50′) has a bushing (52) disposed on a right side of said driven disc (141), the bushing (52) being arranged in a manner that the bushing (52) slides axially and rotates together with said central axle (12), a sliding groove (521) being formed along on outer circumference of said bushing (52); a disk spring (54) provided on a right side of the bushing (52) between the bushing (52) and the other partitioning plate (101′) such that said bushing (52) is biased by the disk spring (54) and abutted against said driven disk (141); a rocking lever (56), a middle portion of which is pivoted on said housing (10), an inner end of said rocking lever (56) being provided with a protruding pin (561) extending into said sliding groove (521), an outer end of said rocking lever (56) extending out of said housing (10); a guide member (57) fixed on said housing (10) corresponding to the outer end of said rocking lever (56); a slider (58) inserted in said guide member (57) and slidably guided therein, said slider (58) being biased by an elastic element (59) and connected with a fire detecting device (70), and the slider (58) is arranged in place so that the outer end of said rocking level (56) is operated by the slider (58).

9. The door machine mechanism (1) of the fireproof door as claimed in claim 8, wherein a first teeth portion (141a) and a second teeth portion (523) are formed on said driven disk (141) and said bushing (52) respectively in such a manner, that the first and second teeth portions (141a, 523) are opposite to and to be engaged with each other.

10. The door machine mechanism (1) of the fireproof door as claimed in claim 9, wherein said fire detecting device (70) is a fusible link which is molten and broken at a temperature exceeding a melting point of the fusible link so that the outer end of said rocking lever (56) is actuated by releasing said slider (58).
